(19) United States
(12) Patent Application Publication
(10) Pub. No.: US 2026/0046568 A1
(43) Pub. Date: Feb. 12, 2026

(54) ACOUSTIC SYSTEM

(71) Applicant: ALPS ALPINE CO., LTD., Tokyo (JP)

(72) Inventor: Tomoki TAKAHATA, Fukushima (JP)

(21) Appl. No.: 19/288,452

(22) Filed: Aug. 1, 2025

(30) Foreign Application Priority Data
Aug. 7, 2024 (JP) 2024-130834

(51) Int. Cl. H04R 9/02; H04R 3/00; H04R 9/04; H04R 9/06

(52) U.S. Cl. CPC H04R 9/025; H04R 3/00; H04R 9/046; H04R 9/06

(57) ABSTRACT

An acoustic system provided with a speaker includes a displacement detector, and a drive unit, wherein the speaker includes a first magnetic gap, a second magnetic gap, and voice coils, wherein the first magnetic gap propagates magnetic flux in one of radial directions of the speaker, the second magnetic gap propagates magnetic flux in another of the radial directions of the speaker, a space between the first magnetic gap and the second magnetic gap in the axial direction is larger than a winding width of each of the voice coils, the vibration system vibrates between a position where at least a portion of the voice coils is positioned within the first magnetic gap and a position where at least a portion of the voice coils is positioned within the second magnetic gap, and the drive unit drives each of the voice coils using the audio signal as a drive signal.

### CROSS-REFERENCE TO RELATED APPLICATION

The present application is based on and claims priority to Japanese patent application No. 2024-130834 filed on Aug. 7, 2024, with Japan Patent Office, the entire contents of which are hereby incorporated by reference.

### BACKGROUND OF THE INVENTION

### 1. Field of the Invention

The disclosure herein relates to a technology for enlarging a stroke width of a speaker capable of effectively controlling drive.

### 2. Description of the Related Art

As a technology related to the present disclosure, there is known a technology for obtaining a constant driving force without depending on displacement of a vibration system of the speaker by providing two magnetic gaps, an upper magnetic gap and a lower magnetic gap with the directions of magnetic flux being opposite, and an upper and a lower voice coil each having a winding width L, the lower voice coil being wound in a direction opposite to that of the upper voice coil, so that the sum of the winding widths of the lower part of the upper voice coil in the upper magnetic gap and the upper part of the lower voice coil in the lower magnetic gap is L (e.g., Patent Literature (PTL) 1).

As a technology related to the present disclosure, there is known a technology for detecting displacement of the vibration system of a speaker by an acceleration sensor, a velocity sensor, a displacement sensor, and the like (e.g., PTL 2).

Even a speaker with a small diameter can reproduce a bass, like a speaker with a large diameter by securing a large stroke width.

In order to enlarge the stroke width, it is required to increase a winding width (coil length) of a voice coil so that the voice coil is not displaced to a position outside the magnetic gap and does not become uncontrollable. However, if the winding width is larger than the width of the magnetic gap, the driving force acting on the voice coil becomes smaller than that of the voice coil whose winding width is about the width of the magnetic gap. Conversely, if the input gain of the voice coil is increased, the driving force acting on the voice coil can be increased, but in this case, power consumption increases. Moreover, if the winding width is increased, the weight of the vibration system including the voice coil increases, which is disadvantageous in terms of output sound pressure and the like.

Accordingly, the present disclosure aims to expand the stroke width of a speaker capable of effectively controlling the drive and minimizing the winding width of the voice coil.

### CITATION LIST

### Patent Literatures

[PTL 1] Japanese Laid-Open Patent Publication No. H9-163495

[PTL 2] Japanese Laid-Open Patent Publication No. 2007-81815

### SUMMARY OF THE INVENTION

An acoustic system provided with a speaker includes a displacement detector configured to detect displacement in an axial direction of the speaker in a vibration system of the speaker, and a drive unit configured to drive the speaker with an audio signal, wherein the speaker includes a first magnetic gap, a second magnetic gap coinciding with the first magnetic gap when viewed in the axial direction, and a plurality of voice coils fixed to the vibration system and spaced apart in the axial direction so as to be positioned within the first magnetic gap and the second magnetic gap when viewed in the axial direction, wherein the first magnetic gap is configured to propagate magnetic flux in one of radial directions of the speaker, the second magnetic gap is configured to propagate magnetic flux in another of the radial directions of the speaker, a space between the first magnetic gap and the second magnetic gap in the axial direction is larger than a winding width of each of the voice coils, the vibration system is configured to vibrate between a position where at least a portion of the plurality of voice coils is positioned within the first magnetic gap and a position where at least a portion of the plurality of voice coils is positioned within the second magnetic gap, and the drive unit is configured to drive each of the voice coils using the audio signal as a drive signal, and to perform at least one of (a) or (b):

(a) when the displacement detected by the displacement detector indicates that a first voice coil of the voice coils is positioned within the first magnetic gap, the drive unit is configured to drive the first voice coil of the voice coils with a drive signal of a first polarity; and (b) when the displacement detected by the displacement detector indicates that a second voice coil of the voice coils is positioned within the second magnetic gap, the drive unit is configured to drive the second voice coil of the voice coils with a drive signal of a second polarity opposite to the first polarity.

An acoustic system provided with a speaker includes a displacement detector configured to detect displacement in an axial direction of the speaker in a vibration system of the speaker, and a drive unit configured to drive the speaker with an audio signal, wherein the speaker includes a first magnetic gap, a second magnetic gap coinciding with the first magnetic gap when viewed in the axial direction, and a first voice coil and a second voice coil fixed to the vibration system so as to be positioned within the first magnetic gap and the second magnetic gap when viewed in the axial direction, wherein when the axial direction of the speaker is a vertical direction, the first magnetic gap is positioned above the second magnetic gap spaced apart in the axial direction, the first voice coil is positioned above the second voice coil spaced apart in the axial direction, the first magnetic gap is configured to propagate magnetic flux in one of radial directions of the speaker, the second magnetic gap is configured to propagate magnetic flux in another of the radial directions of the speaker, a space between the first magnetic gap and the second magnetic gap in the axial direction is larger than a winding width of each of the first voice coil and the second voice coil, the vibration system is configured to vibrate between a position where at least a portion of the first voice coil or at least a portion of the second voice coil is positioned within the first magnetic gap and a position where at least a portion of the first voice coil or at least a portion of the second voice coil is positioned within the second magnetic gap, when the displacement detected by the displacement detector indicates that at least a predetermined proportion of the first voice coil is positioned within the first magnetic gap, the drive unit is configured to drive the first voice coil with a drive signal of a first polarity, when the displacement detected by the displacement detector indicates that at least the predetermined proportion of the first voice coil is positioned within the second magnetic gap, the drive unit is configured to drive the first voice coil with a drive signal of a second polarity opposite to the first polarity, when the displacement detected by the displacement detector indicates that at least a predetermined proportion of the second voice coil is positioned within the first magnetic gap, the drive unit is configured to drive the second voice coil with a drive signal of the first polarity, and when the displacement detected by the displacement detector indicates that at least the predetermined proportion of the second voice coil is positioned within the second magnetic gap, the drive unit is configured to drive the second voice coil with a drive signal of the second polarity opposite to the first polarity.

According to at least one embodiment, the speaker can be driven by selectively applying at least some of the voice coils among the plurality of voice coils provided with different axial ranges to both of the first magnetic gap and the second magnetic gap in which the axial range is different and the direction of magnetic flux is opposite.

### BRIEF DESCRIPTION OF THE DRAWINGS

FIG. 1 is a drawing illustrating a configuration of an acoustic system according to an embodiment of the present disclosure;

FIG. 2A is a drawing illustrating a configuration of a speaker according to the embodiment of the present disclosure;

FIG. 2B is a drawing illustrating a resultant vector of a magnetic flux vector acting from a magnetic circuit and a magnetic flux vector acting from a displacement detection magnet in relation to a magnetic angle;

FIG. 3A is a drawing illustrating a positional relation between a yoke, a first voice coil, a second voice coil, a first plate, a second plate, and a magnet;

FIG. 3B is a drawing illustrating a positional relation between magnetic gaps and voice coils;

FIG. 3C is a drawing illustrating directions of magnetic flux passing through the magnetic gaps;

FIG. 3D is a drawing illustrating an example of force applied to a voice coil bobbin;

FIG. 3E is a drawing illustrating another example of force applied to the voice coil bobbin;

FIG. 3F is a drawing illustrating yet another example of force applied to the voice coil bobbin;

FIG. 3G is a drawing illustrating yet another example of force applied to the voice coil bobbin;

FIG. 4A is a drawing illustrating drive control of the voice coil according to the embodiment of the present disclosure;

FIG. 4B is a drawing illustrating a voice coil having a winding width equal to a length from an upper end of a first voice coil to a lower end of a second voice coil;

FIG. 5 is a drawing illustrating another example of drive control of the voice coil according to the embodiment of the present disclosure;

FIG. 6A is a drawing illustrating another configuration example of the speaker according to the embodiment of the present disclosure;

FIG. 6B is a drawing illustrating yet another configuration example of the speaker according to the embodiment of the present disclosure;

FIG. 6C is a drawing illustrating yet another configuration example of the speaker according to the embodiment of the present disclosure;

FIG. 6D is a drawing illustrating yet another configuration example of the speaker according to the embodiment of the present disclosure;

FIG. 6E is a drawing illustrating yet another configuration example of the speaker according to the embodiment of the present disclosure;

FIG. 6F is a drawing illustrating yet another configuration example of the speaker according to the embodiment of the present disclosure; and

FIG. 7 is a drawing illustrating another configuration example of the acoustic system according to the embodiment of the present disclosure.

### DESCRIPTION OF THE PREFERRED EMBODIMENTS

In the following, embodiments of the present invention will be described with reference to the accompanying drawings.

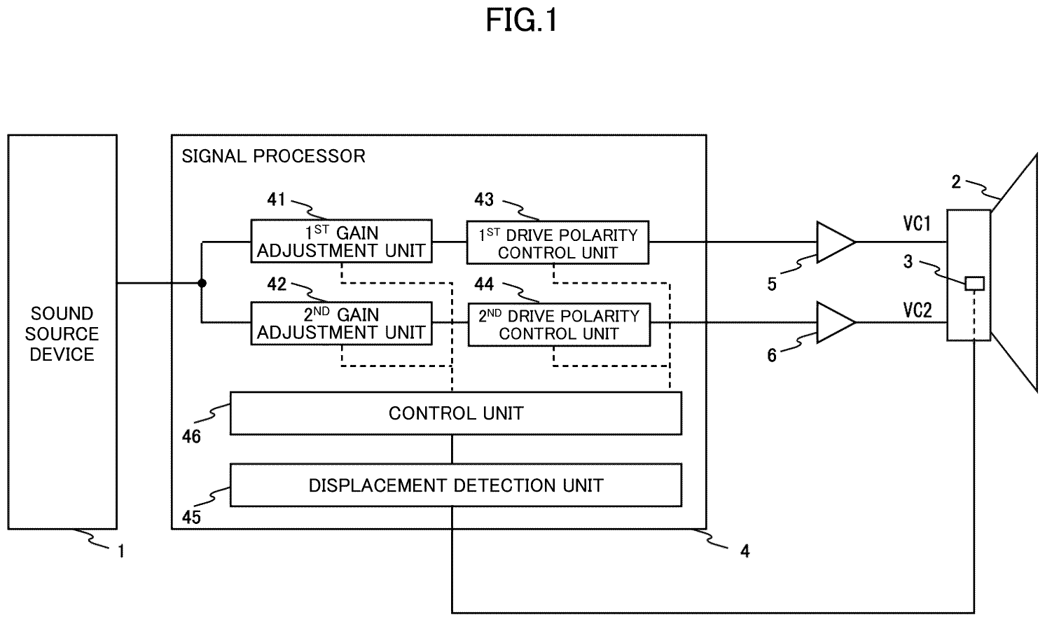

FIG. 1 is a drawing illustrating a configuration of an acoustic system according to the present embodiment.

As shown in the figure, the acoustic system includes a sound source device 1 for outputting audio signals, a speaker 2, a displacement sensor 3 provided in the speaker 2, a signal processor 4, a first amplifier 5, and a second amplifier 6.

The signal processor 4 can be configured using, for example, a DSP (Digital Signal Processor), and includes a first gain adjustment unit 41, a second gain adjustment unit 42, a first drive polarity control unit 43, a second drive polarity control unit 44, a displacement detection unit 45, and a control unit 46. The signal processor 4 is an electronic circuit (including processor) such as a CPU, a GPU, a DSP, an FPGA, and an ASIC, which executes various processing described in the present disclosure by executing instruction codes stored in a memory or by designing a circuit for a special application.

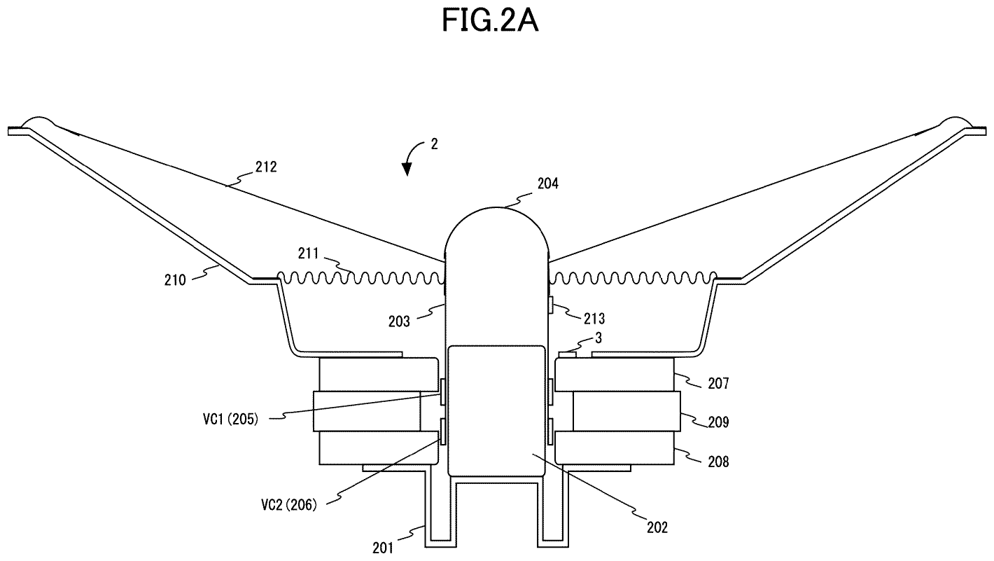

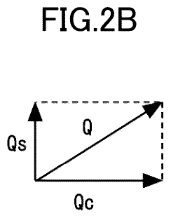

FIG. 2A is a drawing illustrating a configuration of the speaker 2.

As shown in the figure, the speaker 2 includes a base 201, a yoke 202, a voice coil bobbin 203, a dust cap 204, a first voice coil VC1 (205), a second voice coil VC2 (206), a first plate 207, a second plate 208, a magnet 209, a frame 210, a damper 211, a diaphragm 212, and a displacement detection magnet 213.

In an axial direction of the speaker 2, an upper direction in the figure is referred to as an upper direction of the speaker 2, and a lower direction in the figure is referred to as a lower direction of the speaker 2. The yoke 202 has a cylindrical shape and is supported at the center of the base 201. The voice coil bobbin 203 has a hollow tubular shape. The yoke 202 is inserted in the hollow of the voice coil bobbin 203 from the lower direction so that the voice coil bobbin 203 can vertically move relative to the yoke 202. The first voice coil VC1 (205) is wound around the outer periphery of the voice coil bobbin 203, and the second voice coil VC2 (206) is wound at a position away from the first voice coil VC1 (205) in the lower direction.

Further, an annular second plate 208, an annular magnet 209, and an annular first plate 207 supported at the outer periphery of the base 201 are provided outside the voice coil bobbin 203 stacked in this order from below.

Here, the yoke 202 and the second plate 208 are electrically and magnetically separated by the base 201, and a magnetic circuit in which magnetism circulates in an order of the magnet 209, the second plate 208, the yoke 202, the first plate 207, and the magnet 209 is formed by the yoke 202, the second plate 208, the magnet 209, and the first plate 207.

The frame 210 is fixed to the base 201 via the yoke 202, the first plate 207, the magnet 209, and the second plate 208, and the diaphragm 212 is fixed to the frame 210 at its outer peripheral end and to the voice coil bobbin 203 at its inner peripheral end.

Next, the displacement detection magnet 213 is fixed to the outer periphery of the voice coil bobbin 203 so as to move vertically together with the voice coil bobbin 203, and generates a magnetic flux in a direction orthogonal to the magnetic flux generated by the magnetic circuit.

The displacement sensor 3 is fixed at a position close to the displacement detection magnet 213 in a non-vibration system of the speaker 2 such as on the first plate 207. The displacement sensor 3 is a magnetic angle sensor and, as shown in FIG. 2B, detects and outputs an arctangent Qs/Qc of an angle of a resultant vector Q of the magnetic flux vector Qc acting from the magnetic circuit and the magnetic flux vector Qs acting from the displacement detection magnet 213 as a magnetic angle. Due to the displacement of the displacement detection magnet 213 associated with the vertical displacement of the voice coil bobbin 203, the magnetic flux vector generated by the displacement detection magnet 213 acting on the displacement sensor 3 changes, so that the magnetic angle is a value in accordance with the vertical displacement amount of the voice coil bobbin 203, and therefore the vertical displacement position of the vibration system of the speaker 2.

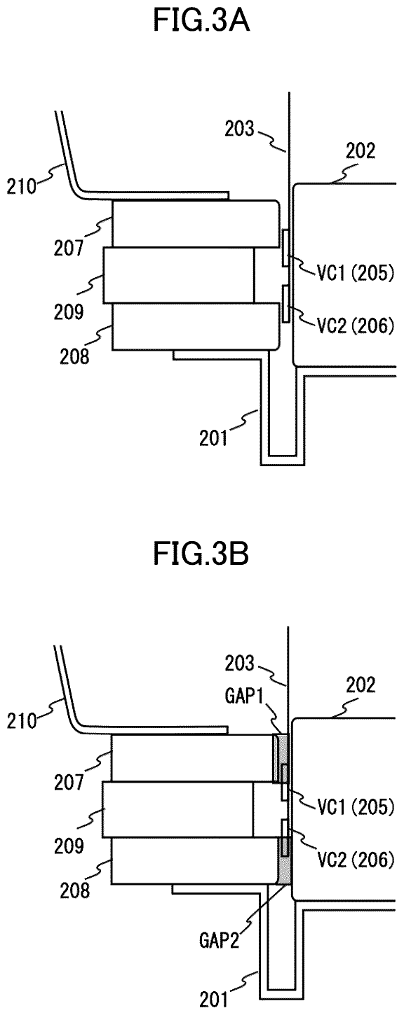

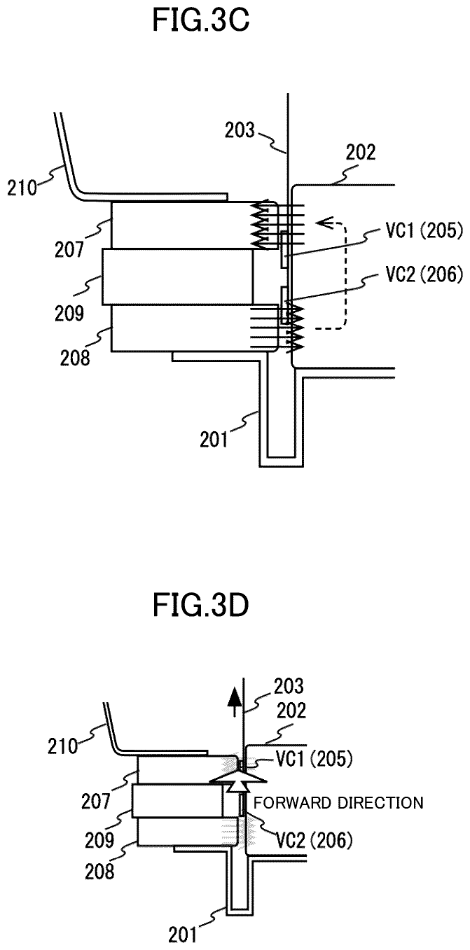

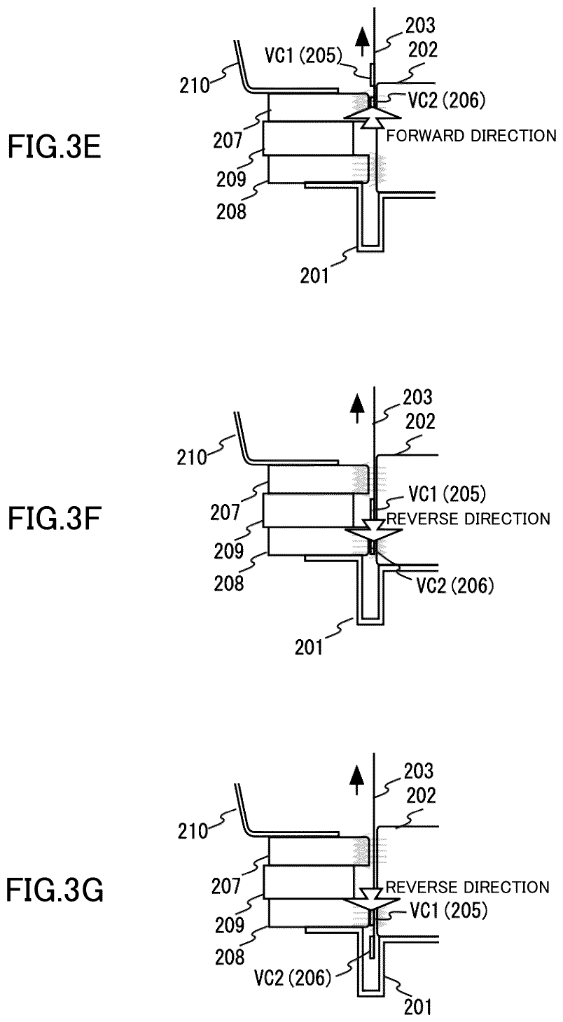

FIG. 3A is a drawing illustrating a positional relation between the yoke 202, the first voice coil VC1 (205), the second voice coil VC2 (206), the first plate 207, the second plate 208, and the magnet 209.

As shown in FIG. 3B, a first magnetic gap GAP1 through which the magnetic flux passes is formed between the first plate 207 and the yoke 202, and a second magnetic gap GAP2 through which the magnetic flux passes is formed between the second plate 208 and the yoke 202. Also, as shown in FIG. 3C, the direction of the magnetic flux passing through the first magnetic gap GAP1 and the direction of the magnetic flux passing through the second magnetic gap GAP2 are opposite in the radial direction of the speaker 2.

The winding widths (coil length/vertical height) of the first voice coil VC1 (205) and the second voice coil VC2 (206) are equal. Further, when the winding widths of the first voice coil VC1 (205) and the second voice coil VC2 (206) are referred to as L, a space between the first magnetic gap GAP1 and the second magnetic gap GAP2 is larger than L so that the first voice coil VC1 (205) and the second voice coil VC2 (206) do not simultaneously enter both of the first magnetic gap GAP1 and the second magnetic gap GAP2. The sizes and arrangements of each part are determined so that with upward movement of the voice coil bobbin 203, the upper end of the second voice coil VC2 (206) enters the first magnetic gap GAP1 before the lower end of the first voice coil VC1 (205) separates upward from the first magnetic gap GAP1, and, with downward movement of the voice coil bobbin 203, the lower end of the first voice coil VC1 (205) enters the second magnetic gap GAP2 before the lower end of the second voice coil VC2 (206) separates downward from the second magnetic gap GAP2.

In the present embodiment, a case where a vertical width of the first magnetic gap GAP is 1.5 L, a vertical width of the second magnetic gap GAP2 is 1.5 L, a vertical width of the space between the first magnetic gap GAP1 and the second magnetic gap GAP2 is 1.5 L, and a vertical space between the first voice coil VC1 (205) and the second voice coil VC2 (206) is 0.5 L, is shown as an example.

In the present embodiment, in a neutral state where no signal is applied to the first voice coil VC1 (205) or the second voice coil VC2 (206), the first voice coil VC1 (205) and the second voice coil VC2 (206) are arranged so that an upper half of the first voice coil VC1 (205) is positioned within a lower part of the first magnetic gap GAP1, and a lower half of the second voice coil VC2 (206) is positioned within an upper part of the second magnetic gap GAP2.

Next, when the direction of the magnetic flux passing through the first magnetic gap GAP1 and the direction of the magnetic flux passing through the second magnetic gap GAP2 are as shown in FIG. 3C, with a direction of a current from the front surface of each of the sheets of FIGS. 3C to 3G toward the back surface being referred to as a forward direction, and a direction of a current from the back surface of each of the sheets of FIGS. 3C to 3G toward the front surface being referred to as a reverse direction, when at least a portion of the first voice coil VC1 (205) is positioned within the first magnetic gap GAP1 when the current flows in the forward direction to the first voice coil VC1 (205) as shown in FIG. 3D, an upward force is applied to the voice coil bobbin 203. Similarly, as shown in FIG. 3E, when at least a portion of the second voice coil VC2 (206) is positioned within the first magnetic gap GAP1 when the current flows in the forward direction to the second voice coil VC2 (206), an upward force is applied to the voice coil bobbin 203. Conversely, as shown in FIG. 3F, when at least a portion of the first voice coil VC1 (205) is positioned within the second magnetic gap GAP2 when a current flows in the reverse direction to the first voice coil VC1 (205), a downward force is applied to the voice coil bobbin 203. Similarly, as shown in FIG. 3G, when at least a portion of the second voice coil VC2 (206) is positioned within the second magnetic gap GAP2 when a current flows in the reverse direction to the second voice coil VC2 (206), a downward force is applied to the voice coil bobbin 203.

Therefore, as long as at least a portion of at least one of the first voice coil VC1 (205) and the second voice coil VC2 (206) is positioned within at least one of the first magnetic gap GAP1 and the second magnetic gap GAP2, the audio signal is applied to the first voice coil VC1 (205) and the second voice coil VC2 (206) with an appropriate polarity and gain, and by an electromagnetic action of the magnetic flux generated in the first magnetic gap GAP1 and the second magnetic gap GAP2 and the current flowing through the first voice coil VC1 (205) and the second voice coil VC2 (206), the vibration corresponding to an amplitude of the audio signal is applied to the diaphragm 212 via the voice coil bobbin 203 to generate a sound corresponding to the audio signal.

Returning to FIG. 1, the displacement detection unit 45 of the signal processor 4 calculates the vertical displacement position ΔZ of the vibration system of the speaker 2 from the magnetic angle detected by the displacement sensor 3 and outputs it to the control unit 46.

Furthermore, the first gain adjustment unit 41 adjusts the gain of the audio signal input from the sound source device 1 with the gain set by the control unit 46 and outputs it to the first drive polarity control unit 43, and the second gain adjustment unit 42 adjusts the gain of the audio signal input from the sound source device 1 with the gain set by the control unit 46 and outputs it to the second drive polarity control unit 44.

The first drive polarity control unit 43 outputs the audio signal input from the first gain adjustment unit 41 to the first amplifier 5, switches between presence and absence of the audio signal output to the first amplifier 5 according to the control unit 46, and switches between positive and negative polarities of the audio signal output to the first amplifier 5 according to the control unit 46. Similarly, the second drive polarity control unit 44 outputs the audio signal input from the second gain adjustment unit 42 to the second amplifier 6, switches between presence and absence of the audio signal output to the second amplifier 6 according to the control unit 46, and switches between positive and negative polarities of the audio signal output to the second amplifier 6 according to the control unit 46.

The first amplifier 5 amplifies the audio signal input from the first drive polarity control unit 43 with a fixed gain and outputs it to the first voice coil VC1 (205) of the speaker 2, and the second amplifier 6 amplifies the audio signal input from the second drive polarity control unit 44 with the same gain as the first amplifier 5 and outputs it to the second voice coil VC2 (206) of the speaker 2.

The control of the first drive polarity control unit 43 and the second drive polarity control unit 44 performed by the control unit 46 will be described below.

In accordance with the vertical displacement position ΔZ of the vibration system of the speaker 2 calculated by the displacement detection unit 45, the control unit 46 controls switching between presence and absence of outputs of the first drive polarity control unit 43 and the second drive polarity control unit 44 and switching between positive and negative polarities of the output audio signal.

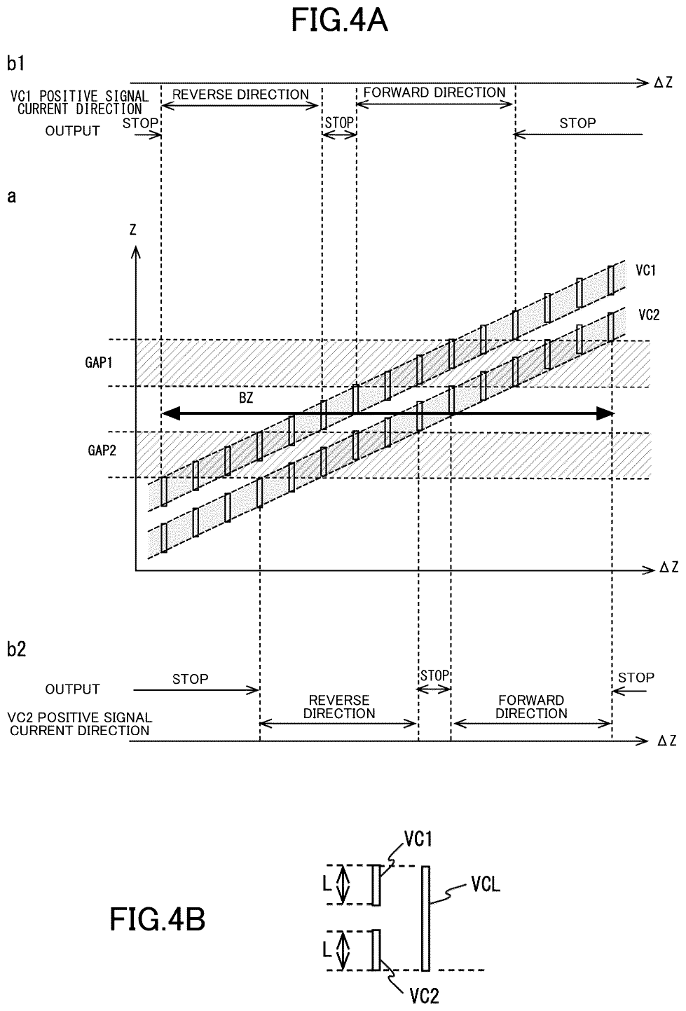

Portion a of FIG. 4A illustrates a positional relation between the displacement position ΔZ, the first voice coil VC1 (205), the second voice coil VC2 (206), the first magnetic gap GAP1, and the second magnetic gap GAP2. Portion b1 of FIG. 4A shows the relation between the displacement position ΔZ, the presence and absence of outputs of the first drive polarity control unit 43 to the first amplifier 5, and the positive and negative polarities of the audio signal output to the first amplifier 5. The positive and negative polarities of the audio signal output to the first amplifier 5 are indicated by the direction of the current flowing to the first voice coil VC1 (205) when the value of the audio signal input to the first drive polarity control unit 43 is positive. Portion b2 of FIG. 4A shows the relation between the displacement position ΔZ, the presence and absence of outputs of the second drive polarity control unit 44 to the second amplifier 6, and the positive and negative polarities of the audio signal output to the second amplifier 6. The positive and negative polarities of the audio signal output to the second amplifier 6 are indicated by the direction of the current flowing to the second voice coil VC2 (206) when the value of the audio signal input to the second drive polarity control unit 44 is positive.

The directions of currents flowing through the first voice coil VC1 (205) and the second voice coil VC2 (206) are indicated by the forward and reverse directions shown in FIGS. 3D to 3G.

As shown, the control unit 46 controls the output of the first drive polarity control unit 43 to the first amplifier 5 so as to stop the output to the first amplifier 5 when the entire first voice coil VC1 (205) is within neither the first magnetic gap GAP1 nor the second magnetic gap GAP2.

The control unit 46 controls the positive and negative polarities of the audio signal output to the first amplifier 5 by the first drive polarity control unit 43 so that when at least a portion of the first voice coil VC1 (205) is within the first magnetic gap GAP1, a current flows in the forward direction to the first voice coil VC1 (205) when the value of the audio signal input to the first drive polarity control unit 43 is positive, and when at least a portion of the first voice coil VC1 (205) is within the second magnetic gap GAP2, a current flows in the reverse direction to the first voice coil VC1 (205) when the value of the audio signal input to the first drive polarity control unit 43 is positive.

The control unit 46 controls the output of the second drive polarity control unit 44 to the second amplifier 6 so as to stop the output to the second amplifier 6 when the entire second voice coil VC2 (206) is within neither the second magnetic gap GAP2 nor the first magnetic gap GAP1.

The control unit 46 controls the positive and negative polarities of the audio signal output to the second amplifier 6 by the second drive polarity control unit 44 so that when at least a portion of the second voice coil VC2 (2056) is within the second magnetic gap GAP2, a current flows in the reverse direction to the second voice coil VC2 (206) when the value of the audio signal input to the second drive polarity control unit 44 is positive, and when at least a portion of the second voice coil VC2 (206) is within the first magnetic gap GAP1, a current flows in the forward direction to the second voice coil VC2 (206) when the value of the audio signal input to the second drive polarity control unit 44 is positive.

As a result, when the displacement position ΔZ is within the range BZ between the position where the upper end of the first voice coil VC1 (205) is at the lower end of the second magnetic gap GAP2 and the position where the lower end of the second voice coil VC2 (206) is at the upper end of the first magnetic gap GAP1 in Portion a of FIG. 4A, at least a portion of at least one of the first voice coil VC1 (205) and the second voice coil VC2 (206) is within at least one of the first magnetic gap GAP1 and the second magnetic gap GAP2, the driving force by at least one of the first voice coil VC1 (205) and the second voice coil VC2 (206) can be exerted, and within the range BZ, by the control of the control unit 46 shown in Portions b1 and b2 of FIG. 4A, the vibration system of the speaker 2 can be vibrated by applying a force to the voice coil bobbin 203 in a proper direction with respect to the positive and negative polarities of the audio signal output from the sound source device 1.

Here, if only the first magnetic gap GAP1 is provided as the magnetic gap and the driving force is exerted within the range BZ by a single voice coil, a voice coil VCL having a winding width equal to the length from the upper end of the first voice coil VC1 (205) to the lower end of the second voice coil VC2 (206), which exceeds the sum of the winding widths of the first voice coil VC1 (205) and the second voice coil VC2 (206) of 2 L as shown in FIG. 4B, would be required.

Therefore, according to the present embodiment, it is possible to increase the stroke width of the speaker 2 which can effectively control the drive without using a voice coil with a large winding width. Moreover, since the structure of the magnetic circuit is symmetrical in the upper and lower directions, asymmetric distortion is not appreciably generated.

Referring back to FIG. 1, the control unit 46 controls the gain of the first gain adjustment unit 41 and the gain of the second gain adjustment unit 42 in accordance with the preset correspondence between the displacement position ΔZ and the combination of the gain of the first gain adjustment unit 41 and the gain of the second gain adjustment unit 42 so as to obtain a response of the driving force of the vibration system by the first voice coil VC1 (205) and the second voice coil VC2 (206), which are targeted to the audio signal output by the sound source device 1 in the above configuration.

The correspondence between the displacement position ΔZ and the combination of the gain of the first gain adjustment unit 41 and the gain of the second gain adjustment unit 42 is determined so that the upper and lower limit of the displacement position ΔZ for the audio signal output by the sound source device 1 is within the range BZ.

The embodiments of the present disclosure have been described above.

In the above-described embodiments, the first voice coil VC1 (205) is driven when at least a portion of the first voice coil VC1 (205) is within the first magnetic gap GAP1 or the second magnetic gap GAP2, and the second voice coil VC2 (206) is driven when at least a portion of the second voice coil VC2 (206) is within the first magnetic gap GAP1 or the second magnetic gap GAP2. However, the output to the first voice coil VC1 (205) may be stopped when a portion of the first voice coil VC1 (205) at least a predetermined winding width (e.g., 10% of the winding width of the first voice coil VC1 (205)) is not within the first magnetic gap GAP1 or the second magnetic gap GAP2, and the output to the second voice coil VC2 (206) may be stopped when a portion of the second voice coil VC2 (206) of at least a predetermined winding width (e.g., 10% of the winding width of the second voice coil VC2 (206)) is not within the first magnetic gap GAP1 or the second magnetic gap GAP2.

In the above-described embodiment, the control unit 46 may control to limit the range of the displacement position ΔZ of the vibration system so that the sum of the ranges of the first voice coil VC1 (205) and the second voice coil VC2 (206) within either the first magnetic gap GAP1 or the second magnetic gap GAP2 does not deviate from the range where the above sum of the ranges of the first voice coil VC1 (205) and the second voice coil VC2 (206) is at least a predetermined width (vertical length).

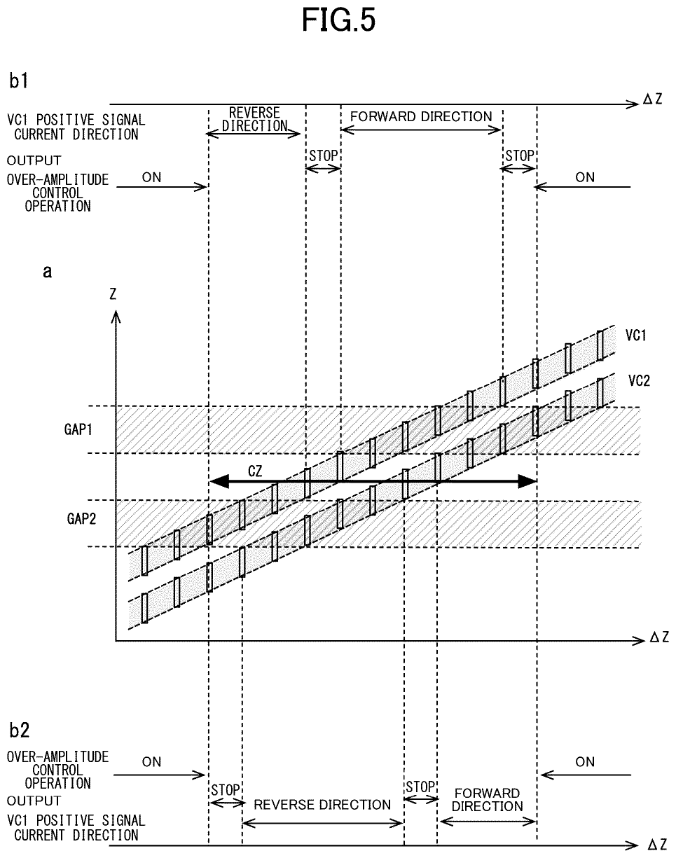

That is, for example, as shown in Portion a of FIG. 5, over-amplitude protection control may be performed so that the displacement position ΔZ does not deviate from the range CZ between the position where the lower end of the first voice coil VC1 (205) is at the lower end of the second magnetic gap GAP2 and the position where the upper end of the second voice coil VC2 (206) is at the upper end of the first magnetic gap GAP1 so that the sum of the ranges of the first voice coil VC1 (205) and the second voice coil VC2 (206) within either of the first magnetic gap GAP1 and the second magnetic gap GAP2 is L or more.

In this case, the correspondence between the displacement position ΔZ and the combination of the gain of the first gain adjustment unit 41 and the gain of the second gain adjustment unit 42 is determined so that the upper and lower limit of the response of the displacement position ΔZ to the audio signal output by the assumed sound source device 1 is within the range CZ.

By limiting the range of the displacement position ΔZ to the range CZ as shown in Portion a, the sum of the ranges of the first voice coil VC1 (205) and the second voice coil VC2 (206) within either the first magnetic gap GAP1 or the second magnetic gap GAP2 is always L within the range CZ. Therefore, the range in which the magnitude of the magnetic flux passing through the first voice coil VC1 (205) and the second voice coil VC2 (206) is linear is enlarged, and the same driving force can be achieved over a wide range.

In this case, the over-amplitude protection control can be achieved, for example, by controlling the control unit 46 as shown in Portions b1 and b2 of FIG. 5. That is, the control unit 46 causes the first drive polarity control unit 43 to control the positive and negative polarities of the audio signal output to the first amplifier 5 so that a current flows in the forward direction to the first voice coil VC1 (205) when the value of the audio signal input to the first drive polarity control unit 43 is positive between a position where the lower end of the first voice coil VC1 (205) is located at the upper end of the first magnetic gap GAP1 and the position where the upper end of the first voice coil VC1 (205) is located at the lower end of the first magnetic gap GAP1. Additionally, the control unit 46 causes the first drive polarity control unit 43 to control the positive and negative polarities of the audio signal output to the first amplifier 5 so that a current flows in the reverse direction to the first voice coil VC1 (205) when the value of the audio signal input to the first drive polarity control unit 43 is positive between a position where the lower end of the first voice coil VC1 (205) is located at the upper end of the second magnetic gap GAP2 and the position where the lower end of the first voice coil VC1 (205) is located at the lower end of the second magnetic gap GAP2. Further, the control unit 46 causes the first drive polarity control unit 43 to control the output of the first drive polarity control unit 43 to the first amplifier 5 so that the output of the first drive polarity control unit 43 to the first amplifier 5 is stopped in the range of other positions within the range CZ.

Further, the control unit 46 controls the positive and negative polarities of the audio signal output to the second amplifier 6 by the second drive polarity control unit 44 so that a current flows in the reverse direction to the first voice coil VC1 (205) when the value of the audio signal input to the second drive polarity control unit 44 is positive between a position where the upper end of the second voice coil VC2 (206) is at the lower end of the second magnetic gap GAP2 and a position where the lower end of the second voice coil VC2 (206) is at the upper end of the second magnetic gap GAP2, and between the position where the upper end of the second voice coil VC2 (206) is at the lower end of the first magnetic gap GAP1 and a position where the upper end of the second voice coil VC2 (206) is at the upper end of the first magnetic gap GAP1, the output of the second drive polarity control unit 44 to the second amplifier 6 is controlled so that the second drive polarity control unit 44 controls the positive and negative polarities of the audio signal output to the second amplifier 6 so that a current flows in the forward direction to the first voice coil VC1 (205) when the value of the audio signal input to the first drive polarity control unit 43 is positive, and the output to the second amplifier 6 is stopped in the range of other positions within the range CZ.

Over-amplitude control operation is performed in the range where the displacement position ΔZ is larger than the range CZ and in the range where the displacement position ΔZ is smaller than the range CZ. In the range where the displacement position ΔZ is larger than the range CZ, the second drive polarity control unit 44 generates a brake signal to give the second voice coil VC2 (206) a driving force in the direction opposite to the displacement direction indicated by the displacement position ΔZ and outputs it to the second amplifier 6 instead of the audio signal. In the range where the displacement position ΔZ is smaller than the range CZ, the first drive polarity control unit 43 generates a brake signal to give the first voice coil VC1 (205) a driving force in the direction opposite to the displacement direction indicated by the displacement position ΔZ and outputs it to the first amplifier 5 instead of the audio signal.

In the above embodiments, the case where two voice coils, the first voice coil VC1 (205) and the second voice coil VC2 (206), are used as the voice coils is described, but a larger number of voice coils may be provided.

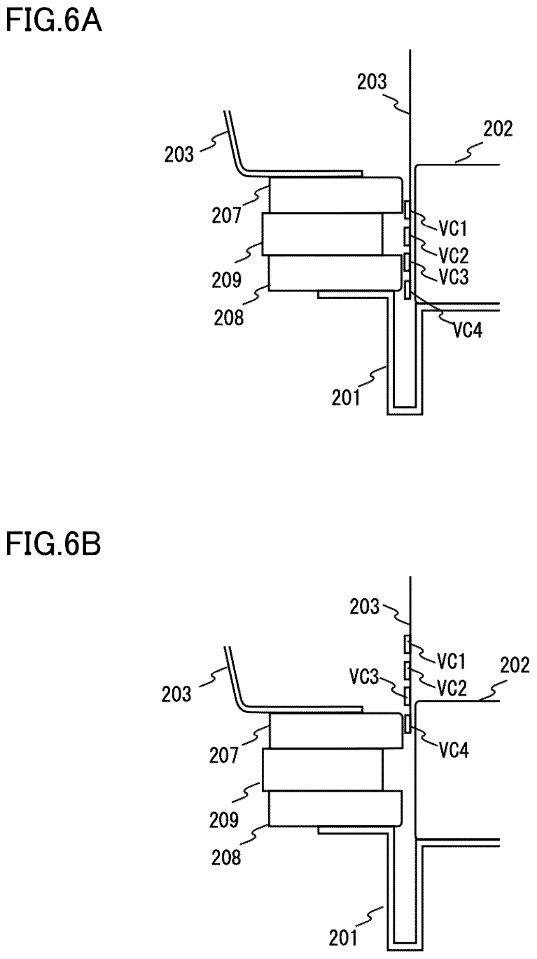

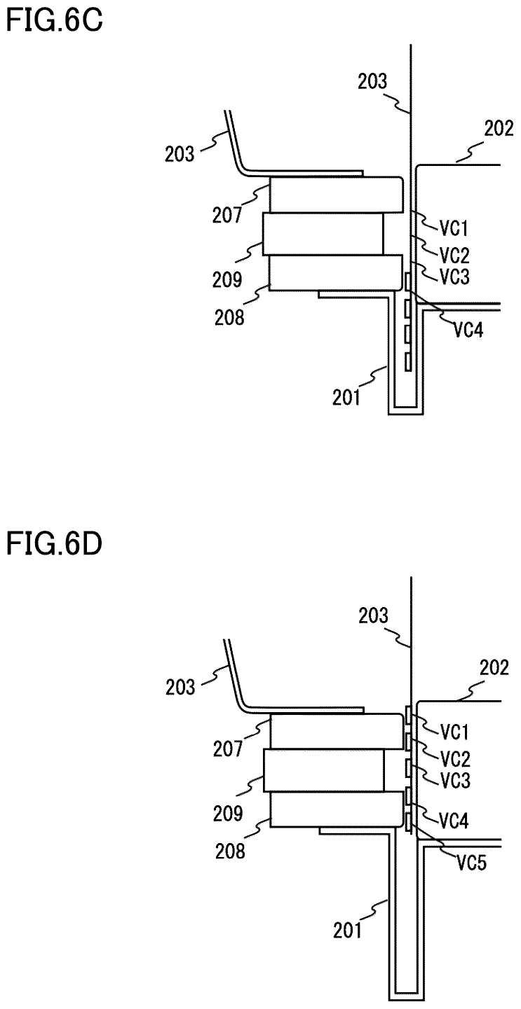

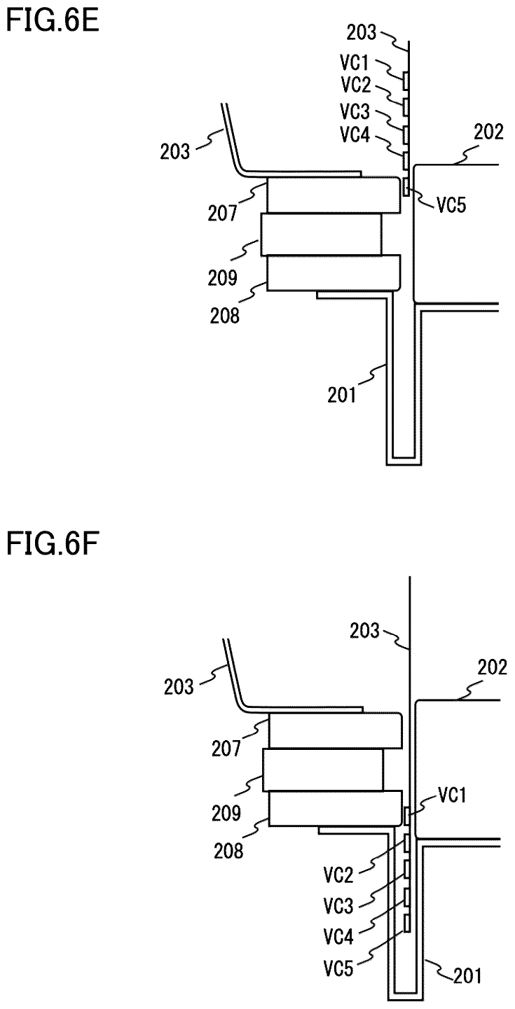

For example, four voice coils VC1 to VC4 may be arranged in the voice coil bobbin 203 as shown in FIG. 6A.

According to the arrangement shown in FIG. 6A, in the stroke range between FIG. 6B and FIG. 6C, the vibration system of the speaker 2 can be vibrated by making the total of the windings of all voice coils in either of the first magnetic gap GAP1 and the second magnetic gap GAP2 L or more.

Alternatively, five voice coils VC1 to VC5 may be arranged in the voice coil bobbin 203 as shown in FIG. 6D.

According to the arrangement shown in FIG. 6D, in the stroke range between FIG. 6E and FIG. 6F, the vibration system of the speaker 2 can be vibrated.

The vibration system of the speaker 2 can be vibrated when the sum of the windings of all the voice coils in either the first magnetic gap GAP1 or the second magnetic gap GAP2 is L or more.

FIGS. 6A and 6D show the case where the vertical width of the first magnetic gap GAP is 1.5 L, the vertical width of the second magnetic gap GAP2 is 1.5 L, the vertical width of the space between the first magnetic gap GAP1 and the second magnetic gap GAP2 is 1.5 L, and the vertical space between the adjacent voice coils VC is 0.5 L. According to this configuration, the same voice coil VCi (i=1, 2, . . . n) does not simultaneously enter both the first magnetic gap GAP1 and the second magnetic gap GAP2. Further, when the voice coil bobbin 203 moves upward, the upper end of the (k+1)th voice coil VCk+1 enters the first magnetic gap GAP1 before the lower end of the kth voice coil VCk (k=1, 2, . . . n-1) leaves the first magnetic gap GAP1 upward, and when the voice coil bobbin 203 moves downward, the lower end of the (j−1)th voice coil VCj-1 enters the second magnetic gap GAP2 before the lower end of the jth voice coil VCj (j=2, 3, . . . n) leaves the second magnetic gap GAP2 downward.

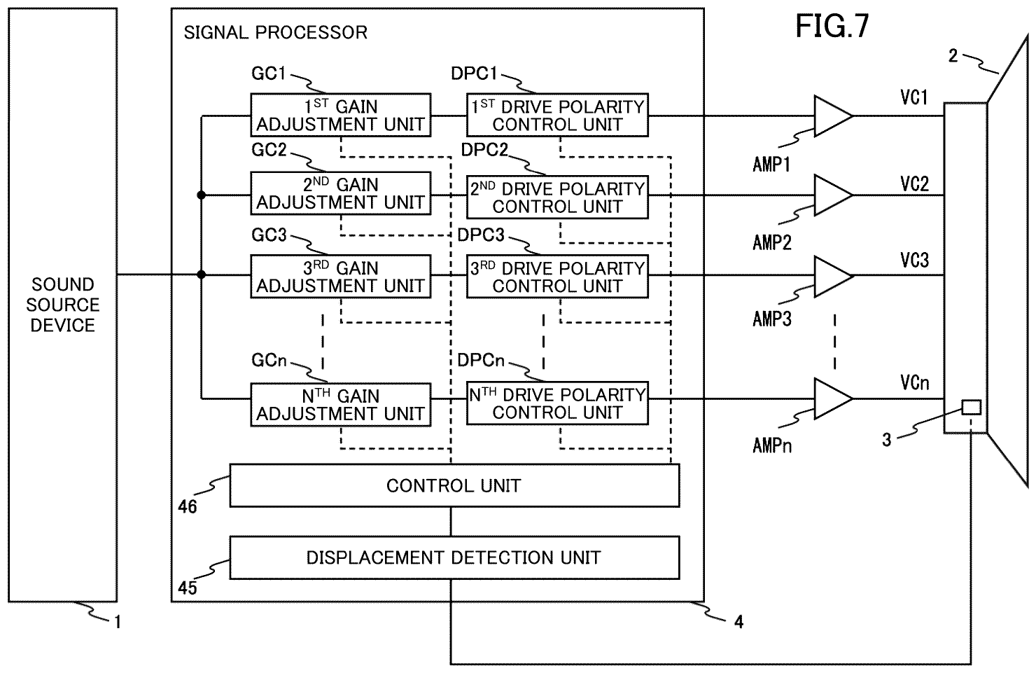

When more n number of voice coils are provided as shown in FIGS. 6A and 6D, a set of the ith gain control unit GCi, the ith drive polarity control unit DPCi, and the ith amplifier AMPi corresponding to each voice coil VCi (i=1, 2, . . . n) is provided as shown in FIG. 7, and when the entire voice coil VCi is within neither the first magnetic gap GAP1 nor the second magnetic gap GAP2, the output of the audio signal output to the ith amplifier by the ith drive polarity control unit is controlled so as to stop the output to the voice coil VCi via the ith amplifier AMPi. When at least a portion of the voice coil VCi is in the first magnetic gap GAP1, a current flows in the forward direction to the first voice coil VC1 (205) when the value of the audio signal input to the first drive polarity control unit 43 is positive, and when at least a portion of the first voice coil VC1 (205) is in the second magnetic gap GAP2, a current flows in the reverse direction to the ith voice coil VCi when the value of the audio signal input to the ith drive polarity control unit is positive, so that the positive and negative polarities of the audio signal output to the ith amplifier AMPi by the ith drive polarity control unit are controlled.

What is claimed is

1. An acoustic system provided with a speaker, comprising:
a displacement detector configured to detect displacement in an axial direction of the speaker in a vibration system of the speaker; and
a drive unit configured to drive the speaker with an audio signal,
wherein the speaker includes:
a first magnetic gap;
a second magnetic gap coinciding with the first magnetic gap when viewed in the axial direction; and
a plurality of voice coils fixed to the vibration system and spaced apart in the axial direction so as to be positioned within the first magnetic gap and the second magnetic gap when viewed in the axial direction,
wherein:
the first magnetic gap is configured to propagate magnetic flux in one of radial directions of the speaker;
the second magnetic gap is configured to propagate magnetic flux in another of the radial directions of the speaker;
a space between the first magnetic gap and the second magnetic gap in the axial direction is larger than a winding width of each of the voice coils;
the vibration system is configured to vibrate between a position where at least a portion of the plurality of voice coils is positioned within the first magnetic gap and a position where at least a portion of the plurality of voice coils is positioned within the second magnetic gap; and
the drive unit is configured to drive each of the voice coils using the audio signal as a drive signal, and to perform at least one of (a) or (b):
(a) when the displacement detected by the displacement detector indicates that a first voice coil of the voice coils is positioned within the first magnetic gap, the drive unit is configured to drive the first voice coil of the voice coils with a drive signal of a first polarity; and
(b) when the displacement detected by the displacement detector indicates that a second voice coil of the voice coils is positioned within the second magnetic gap, the drive unit is configured to drive the second voice coil of the voice coils with a drive signal of a second polarity opposite to the first polarity.

2. An acoustic system provided with a speaker, comprising:
a displacement detector configured to detect displacement in an axial direction of the speaker in a vibration system of the speaker; and
a drive unit configured to drive the speaker with an audio signal,
wherein the speaker includes:
a first magnetic gap;
a second magnetic gap coinciding with the first magnetic gap when viewed in the axial direction; and
a first voice coil and a second voice coil fixed to the vibration system so as to be positioned within the first magnetic gap and the second magnetic gap when viewed in the axial direction,
wherein:
when the axial direction of the speaker is a vertical direction, the first magnetic gap is positioned above the second magnetic gap spaced apart in the axial direction,
the first voice coil is positioned above the second voice coil spaced apart in the axial direction;
the first magnetic gap is configured to propagate magnetic flux in one of radial directions of the speaker;
the second magnetic gap is configured to propagate magnetic flux in another of the radial directions of the speaker;
a space between the first magnetic gap and the second magnetic gap in the axial direction is larger than a winding width of each of the first voice coil and the second voice coil;
the vibration system is configured to vibrate between a position where at least a portion of the first voice coil or at least a portion of the second voice coil is positioned within the first magnetic gap and a position where at least a portion of the first voice coil or at least a portion of the second voice coil is positioned within the second magnetic gap;
when the displacement detected by the displacement detector indicates that at least a predetermined proportion of the first voice coil is positioned within the first magnetic gap, the drive unit is configured to drive the first voice coil with a drive signal of a first polarity;
when the displacement detected by the displacement detector indicates that at least the predetermined proportion of the first voice coil is positioned within the second magnetic gap, the drive unit is configured to drive the first voice coil with a drive signal of a second polarity opposite to the first polarity;
when the displacement detected by the displacement detector indicates that at least a predetermined proportion of the second voice coil is positioned within the first magnetic gap, the drive unit is configured to drive the second voice coil with a drive signal of the first polarity; and
when the displacement detected by the displacement detector indicates that at least the predetermined proportion of the second voice coil is positioned within the second magnetic gap, the drive unit is configured to drive the second voice coil with a drive signal of the second polarity opposite to the first polarity.

3. The acoustic system according to claim 2, wherein:
in a first range of the displacement in the vibration system, both at least the predetermined proportion of the first voice coil and at least the predetermined proportion of the second voice coil are positioned within the first magnetic gap;
in a second range of the displacement of the vibration system, both at least the predetermined proportion of the first voice coil and at least the predetermined proportion of the second voice coil are positioned within the second magnetic gap;
when the displacement detected by the displacement detector indicates that both at least the predetermined proportion of the first voice coil and at least the predetermined proportion the second voice coil are positioned within the first magnetic gap, the drive unit is configured to drive the first voice coil and the second voice coil with the drive signal of the first polarity; and
when the displacement detected by the displacement detector indicates that both at least the predetermined proportion of the first voice coil and at least the predetermined proportion of the second voice coil are positioned within the second magnetic gap, the drive unit is configured to drive the first voice coil and the second voice coil with the drive signal of the second polarity.

4. The acoustic system according to claim 3, wherein:
when the displacement detected by the displacement detector indicates that at least the predetermined proportion of the first voice coil is positioned within neither the first magnetic gap nor the second magnetic gap, the drive unit is configured to stop driving the first voice coil; and
when the displacement detected by the displacement detector indicates that at least the predetermined proportion of the second voice coil is positioned within neither the first magnetic gap nor the second magnetic gap, the drive unit is configured to stop driving the second voice coil.

5. The acoustic system according to claim 2, wherein:
at least the predetermined proportion of the first voice coil is at least n % (n>0) of the first voice coil; and
at least the predetermined proportion of the second voice coil is at least n % (n>0) of the second voice coil.

6. The acoustic system according to claim 2, wherein when an upper half of the first voice coil is positioned in a lower part of the first magnetic gap, a lower half of the second voice coil is positioned in an upper part of the second magnetic gap.

7. The acoustic system according to claim 6, wherein when each of the winding width of the first voice coil and the winding width of the second voice coil is referred to as L, the space between the first voice coil and the second voice coil in the axial direction is 0.5 L.

8. The acoustic system according to claim 7, wherein each of the first magnetic gap and the second magnetic gap has a length in the axial direction of 1.5 L.
